(19) United States
(12) Patent Application Publication
(10) Pub. No.: US 2014/0202150 A1
(43) Pub. Date: Jul. 24, 2014

(54) Reciprocating Exhaust Mechanism for Energy Recuperation and Gas Recirculation

(71) Applicant: Ingo Valentin, Elm Grove, WI (US)

(72) Inventor: Ingo Valentin, Elm Grove, WI (US)

(21) Appl. No.: 13/748,782

(22) Filed: Jan. 24, 2013

(51) Int. Cl. F02M 25/07

(52) U.S. Cl. CPC F02M 25/0712
USPC 60/605.2

(57) ABSTRACT

The reciprocating piston of an exhaust pressure wave charger for a combustion engine has an integrated hydraulic piston and an air piston transferring exhaust gas energy into mechanical power and provides exhaust gas for the combustion chamber. The fluid communication between hydraulic piston and hydraulic circuit is controlled by valves to extract the exhaust energy during the expansion stroke and advance the charger piston back into top end position. The hydraulic piston has two faces for adapting the hydraulic piston force more closely to the exhaust gas forces. Exhaust gas recirculation (EGR) is provided by an air piston and valves controlling the flow of exhaust gas into the combustion chamber.

### BACKGROUND OF THE INVENTION

1. Technical Field

The invention relates generally to combustion engines, and particularly to mechanism which extract energy from the exhaust gas and control the exhaust gas recirculation. The mechanism, consisting of an exhaust gas driven, reciprocating piston, pumping pressurized fluid into an accumulator and exhaust gas to the combustion chamber, improving engine efficiency and emissions.

2. Background Art

Currently, exhaust gas driven rotational mechanisms as turbo and pressure wave chargers are utilized to charge the combustion chamber with pressurized air, increasing the power density and efficiency of the engine. Belt or gear driven compressors overcome the shortcomings of the chargers but reduce the gains in efficiency.

Turbo chargers, where the exhaust driven turbine drives an impeller to charge fresh air into the combustion chamber, operate at very high speeds to obtain sufficient efficiencies. Their reaction to load changes is slow (turbo lag) and the operating profiles of engine and charger overlap only partly. Extended air flow circuits or additional turbo chargers overcome the shortcomings in operating profiles, but increase the weight, size and costs. Compressors fulfill the requirements, but consume power for driving them.

Compound charge mechanisms transfer power from the exhaust turbine mechanically to the crankshaft, improving power output and efficiency, but increase the complexity and costs of the engine noticeably.

Pressure wave chargers, utilizing a belt driven rotating cell structure, transfer the exhaust pressure wave directly into the intake pressure wave. The charger fulfills the operating requirements of the engine, but the uncontrollable mixing of exhaust and fresh air within each cell and the heat transfer between the gases are drawbacks. Wave chargers with a reciprocating piston separate the exhaust and intake wave physically, but are not utilized to transfer mechanical power to the drive system to increase power output and efficiency.

EGR mechanisms utilize tubes and valves, actuated by the engine management system, to control the flow of exhaust gas to the combustion chamber utilized for reducing the emissions. The mechanisms are space consuming and costly.

In a known combustion engine with a reciprocating pressure wave charger, disclosed in U.S. Pat. No. 6,293,231 B1, utilizes a charger piston for providing charge air for the combustion chamber. The displacements at the engine exhaust and intake air end of the piston are of the same size, and the intake air end consists of one charge section only.

Although advantageous where a reciprocating exhaust pressure wave charger is utilized, concepts for extracting mechanical energy from the exhaust gas through a mechanical compound mechanism and a charger piston with a separate section for exhaust air for providing exhaust gas for improved combustion conditions (EGR) have not been utilized.

It is therefore an object of the invention to provide simplified mechanisms for extracting mechanical power from the exhaust gas and for controlling the recirculation of exhaust gas for the combustion chamber (EGR) for increased engine efficiency and reduced emissions.

### BRIEF SUMMARY OF THE INVENTION

Typically, pressure wave charger having a piston bore with a centrally mounted reciprocating charger piston. Typically, the first piston end is driven by exhaust gas energy, and the opposing air end charges the combustion chamber with pressurized air. In accordance with the present invention, the charger piston has a second opposing air end for charging the combustion chamber with exhaust gas (EGR) and a third opposing hydraulic end for extracting mechanical energy from the charger piston.

The piston chamber of the second air end is in fluid communication with the exhaust and the combustion chamber of the engine. Valves control the ingress from the exhaust and egress to the combustion chamber, and the amount of EGR provided.

The hydraulic end is in fluid communication with a low pressure and high pressure section of the hydraulic circuit, controlled by valves. During the expansion stroke of the charger piston, fluid is provided to the high pressure section of the hydraulic circuit. The force for returning the piston into TDC position is provided by fluid from the low pressure section or a bias structure (spring).

For increased utilization of the exhaust energy, the hydraulic end has a smaller inner and a larger outer face in fluid connection with the low pressure and high pressure section of the circuit. Directional control valves determine the flow of fluid between the sections of the hydraulic system and the faces at the hydraulic end. During the period of high exhaust gas pressure and high piston forces, the larger outer face is in fluid communication with the high pressure section of the hydraulic circuit. With declining exhaust pressure at the end of the expansion stroke, fluid communication between both faces requiring less piston force to advance high pressure fluid into the hydraulic circuit, increasing the recuperation of exhaust gas energy.

The structures of the second air and hydraulic ends are expected to minimize heat, friction and leakage losses, and to reduce space requirements and weight when compared to current systems.

### BRIEF DESCRIPTION OF THE DRAWINGS

The features of the present invention which are believed to be novel are set forth with particularity in the appended claims. The invention, together with the further objects and advantages thereof, may be best understood by reference to the following description taken in conjunction with the accompanying drawings, wherein like reference numerals identify like elements, and wherein:

FIG. 1 is a simplified representation of a combustion engine with a reciprocating charge mechanism having an exhaust gas driven charger piston with an integrated hydraulic compound and exhaust gas recirculation mechanism in accordance with the invention.

FIG. 2 is a simplified presentation of the combustion engine of FIG. 1 with a hydraulic piston having a larger outer face and a smaller opposing inner face for extracting exhaust gas energy.

FIG. 3 is a presentation of a hydraulic compound mechanism with a hydraulic piston having two outer faces for extracting energy.

FIG. 4 is a presentation of a compound mechanism with a hydraulic piston having a larger outer and an opposing smaller inner face for extracting exhaust gas energy and hydraulically controlling the reciprocating movement of the charger piston.

FIG. 5 is a conceptual presentation of a p-v diagram (pressure vs. volume) diagram of the combustion engine, and the charge mechanism with hydraulic compound mechanism.

### DETAILED DESCRIPTION OF THE PREFERRED EMBODIMENTS

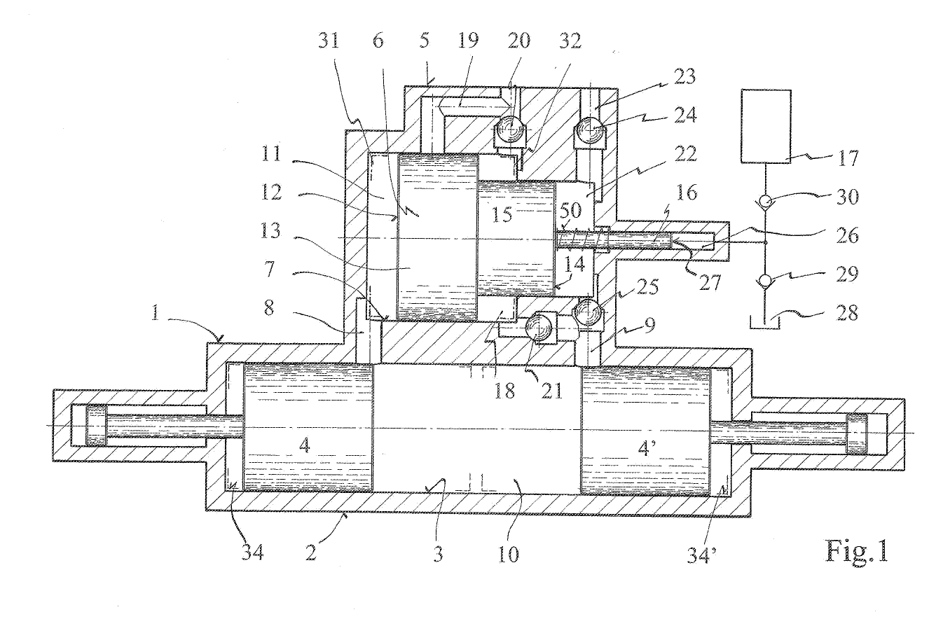

The exhaust mechanism, shown in FIG. 1, consists of free-piston engine 1, engine housing 2, engine piston bore 3, and a pair of free-pistons 4 and 4′ reciprocably mounted therein. The compound charge mechanism 5, attached to the engine, has a charger piston 6 reciprocally mounted in charger piston bore 7, driven by the exhaust gas pressure from free-piston engine 1. Exhaust port 8 and air intake port 9 provide fluid communication between combustion chamber 10 and charge mechanism 5.

Piston 4 opens exhaust port 8 providing exhaust gas to chamber 11 and face 12 at air end 13 of charger piston 6 transfers the exhaust gas pressure directly into pressurized fresh air at face 14, pressurized exhaust air at face 15 for charging combustion chamber 10, and pressurized fluid at hydraulic end 16 to be stored in accumulator 17, thus reducing the losses of exhaust gas energy and frictional, and the size and cost of the compound charge mechanism 5.

Air end 13 having exhaust chamber 18 with face 15 is in fluid communication with exhaust port 19 (muffler) through non-return valve 20, and with combustion chamber 10 through air intake port 9 and non-return valve 21. Fresh air chamber 22 at face 14 is in fluid communication with the air intake 23 (air filter) through non-return valve 24 and intake port 9 through non-return valve 25.

Hydraulic end 16 having chamber 26 with outer piston face 27 is in fluid communication with reservoir 28 through non-return valve 29 and to accumulator 17 through non-return valve 30.

More specifically, the charger piston 6 reciprocates within charger piston bore 7 between top-end position 31 and bottom-end position 32 (represented by dashed lines) by the forces of the exhaust gas pressure wave from the combustion chamber 10. Initially, spring 50, acting in opposite direction of the exhaust gas force at face 12, advance charger piston 6 into top end position 31, drawing fresh air from air intake 23 through non-return valve 24 into chamber 22, exhaust gas from port 19 through non-return valve 20 into chamber 18, and hydraulic fluid from reservoir 28 through non-return valve 29 into chamber 26 of hydraulic end 16.

After combustion, pistons 4, 4′ advance towards their bottom end position 34, 34′, providing pressurized exhaust gas to face 12, driving charger piston 6 towards bottom end position 32, pumping fresh air from chamber 22 through valve 25, and exhaust air from chamber 18 through valve 21 into combustion chamber 10. Simultaneously, hydraulic fluid is pumped from chamber 26 through valve 30 into accumulator 17, storing the recuperated exhaust gas energy.

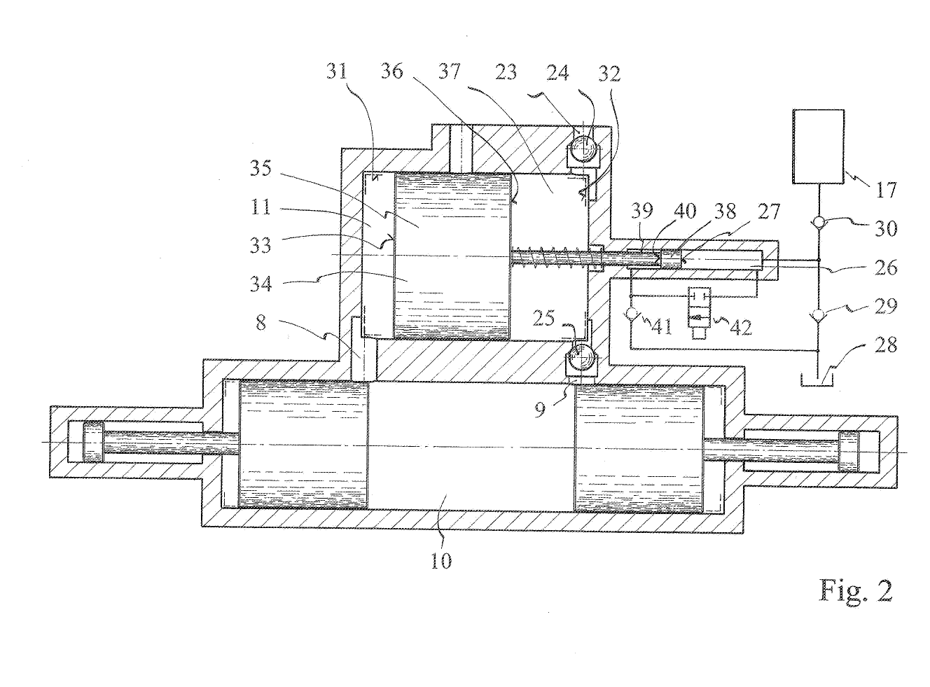

Referring to FIG. 2, Piston 4 opens exhaust port 8 providing exhaust gas to chamber 11 and face 33 of charger piston 35 transferring the exhaust gas directly into pressurized fresh air at face 36 in air chamber 37 for charging combustion chamber 10, and pressurized fluid at hydraulic end 38 stored in accumulator 17. Air chamber 37 is in fluid communication with air intake 23 through non-return valve 24 and intake port 9 through non-return valve 25.

In addition to the configuration in FIG. 1, hydraulic end 38 has a smaller inner chamber 39 with piston face 40, opposing face 27, in fluid communication with reservoir 28 through non return valve 41 and with chamber 26 through fluid control valve 42. Initially, at high exhaust gas pressure, with charger piston 35 in top end position 31, fluid communication between the larger outer face 27 and smaller inner face 40 is closed through control valve 42 and low pressure fluid from reservoir 28 is drawn into chamber 39 through no return valve 41, and high pressure fluid advanced from chamber 26 to accumulator 17 through non return vale 30. At lower gas pressure, control valve 42

opens providing high fluid pressure from chamber 26 to chamber 39, reducing the required gas pressure at face 33 to advance high pressure fluid into accumulator 17 for extracting the reduced amount of exhaust gas energy when approaching bottom end position 32. During suction stroke, hydraulic end 38 draws fluid from reservoir 28 through no return valve 29 and from chamber 39 through control valve 42.

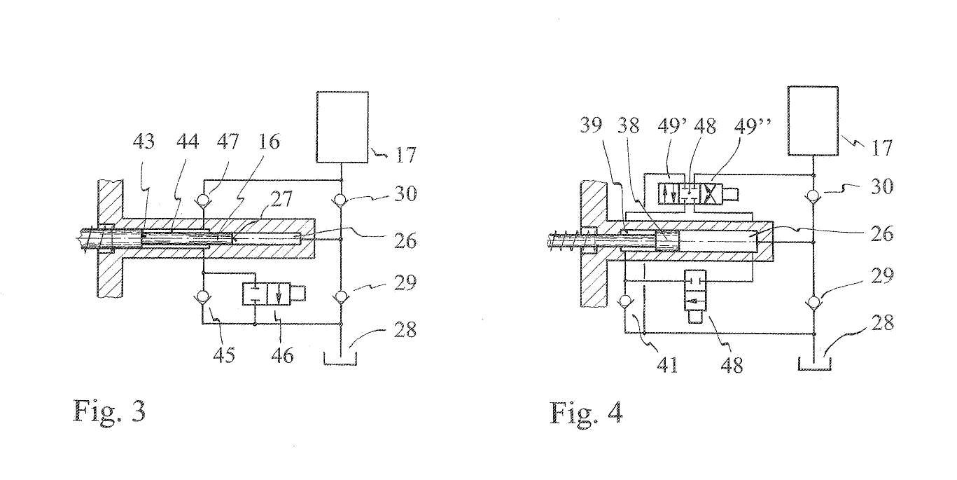

Referring to FIG. 3, hydraulic end 16 with outer face 27 and chamber 26, as shown in FIG. 1, has an additional outer piston face 43 with chamber 44 in fluid communication with reservoir 28 through non return valve 45 and 3/2 control valve 46, and to accumulator 17 through non return valve 47. Initially, at high exhaust gas forces, fluid from chamber 26 and 44 is advanced to accumulator 17. For extracting energy from low exhaust gas pressure, control valve 46 opens and low pressure fluid from chamber 44 is advanced to reservoir 28 for reducing the hydraulic forces at hydraulic end 16. During suction stroke, fluid is drawn from reservoir 28 into chamber 26 through valve 29 and into chamber 44 through valve 45.

Referring to FIG. 4, when extracting exhaust energy, chamber 26 is in fluid communication with accumulator 17 and reservoir 28 through non return valves 30, 29, and chamber 39 with reservoir 28 through non return valve 41 and with chamber 26 through fluid control valve 42, as shown in FIG. 2. Control valve 48 is in direct fluid communication with chambers 26 and 39, and with reservoir 28 and accumulator 17, for providing charge air at air end 13 through a reciprocating movement of hydraulic end 38 when exhaust gas pressure is not available. Valve 48 is in 49′ position, providing pressurized fluid from accumulator 17 to chamber 26 and communication from chamber 39 to reservoir 28 to advance hydraulic end 38 towards top end position 31. Valve 49 in 49″ position provides fluid from accumulator 17 to chamber 39 and fluid communication from chamber 26 to reservoir 28 to advance hydraulic end 38 towards bottom end position.

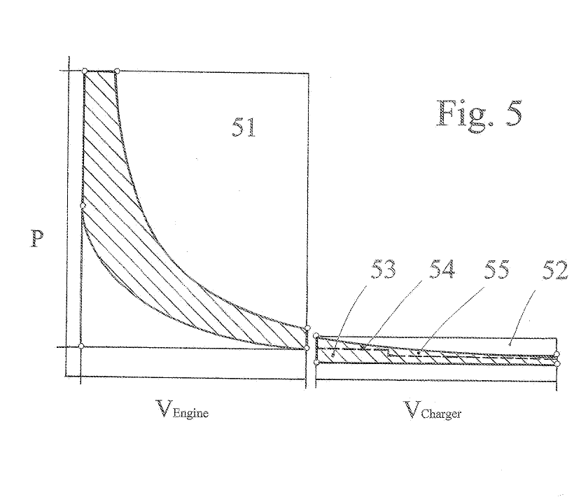

FIG. 5: Diagram 51 is a presentation of the p-V (combustion pressure vs. volume) of combustion engine 1 and diagram 52 of p-V (exhaust gas pressure vs. volume) of charge mechanism 5. Area 53 under line 54 indicates the hydraulic energy extracted from the exhaust gas and area 55 above line 54 the energy for charging the combustion chamber 10 with air.

While preferred embodiments have been illustrated and described, it should be understood that changes and modifications can be made without departing from the invention in its broadest aspect. Various features of the invention are defined in the following claims.

What claimed is:

1. A charge mechanism for a combustion engine comprising:
a housing including a piston bore,
a charger piston, reciprocably mounted in the piston bore, for movement between a bottom-end and top-end position, the piston having an air end and a hydraulic end, the air end having an outer face with an air chamber exposed to pressurized exhaust gas for driving the piston from top-end to bottom-end during the expansion stroke, and two opposing inner faces defining a first and second inner air chamber, the first inner air chamber for charging fresh air into the combustion chamber, and the second inner air chamber,
a fluid control system including a first and second fluid circuit, the first circuit for providing fresh air to the combustion chamber and the second circuit for providing a gas other than fresh air to the combustion chamber,
the first circuit including two no return valves, and first and second fluid conduits, the first conduit and no return valve for providing fluid communication between air inlet and first air chamber, and the second conduit and no return valve for providing communication between first chamber and combustion chamber,
the second circuit including two no return valves, and third and fourth fluid conduits, the third fluid conduit and no return valve for providing fluid communication between the source of gas other than fresh air and the second chamber and the fourth conduit and no return valve for providing fluid communication between the second chambers and combustion chamber.

2. A charge mechanism as defined in claim 1, wherein
said hydraulic end having a piston bore cooperating with a piston having a first face, a first hydraulic chamber, and a first fluid flow control system including, two no return valves, and first and second fluid conduits, the first conduit and no return valve for providing fluid communication between a source of low pressure fluid and the first chamber during the suction stroke and the second fluid conduit and no return valve for supplying pressurized fluid to a storage device during the compression stroke.

3. A charge mechanism as defined in claim 2, wherein
said piston having, a second face and second hydraulic chamber, a second fluid flow control system including two fluid control circuits, the first circuit including a fluid control device, two no return valves, and first, second and third fluid conduits, the first conduit and fluid control device for providing fluid communication between a source of low pressure fluid and the second chamber, the second conduit and no return valve for providing communication between a source of low pressure fluid and the second chamber during the suction stroke, and the third fluid conduit and no return valve for supplying pressurized fluid to a storage device during the compression stroke.

4. A charge mechanism as defined in claim 1, wherein
said hydraulic end having a second face opposing the first face and second opposing chamber, a second fluid flow control system including two fluid control circuits, the first circuit including a no return valve and first and second fluid conduits, the first conduit and no return valve for providing fluid communication between a source of low pressure fluid and the second chamber, and the second fluid control circuit including a fluid control device and third and fourth conduits, for providing fluid communication between first and the second chamber.

5. A charge mechanism as defined in claim 4, wherein
said hydraulic end having a third fluid control system including two fluid control circuits, the first fluid control circuit including a fluid control device and first and second fluid conduits, the first conduit for providing fluid communication between the fluid control device and first chamber, and the second conduit for providing communication between fluid control device and storage device, the second fluid control circuit including the fluid control device and third and fourth conduits, the third conduit for fluid communication between the fluid control device and second chamber, and the fourth conduit for fluid communication between the fluid control device and a source of low pressure fluid.
